(19) United States
(12) Patent Application Publication
(10) Pub. No.: US 2008/0071490 A1
(43) Pub. Date: Mar. 20, 2008

(54) Industrial process evaluation system, industrial process evaluation method and recording medium storing industrial process evaluation program

(75) Inventor: Yasunori Nakamura, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/892,329

(22) Filed: Aug. 22, 2007

(30) Foreign Application Priority Data
Sep. 20, 2006 (JP) JP2006-254063

(51) Int. Cl. G06F 19/00

(52) U.S. Cl. 702/82

(57) ABSTRACT

An alarm detection part 103 monitors each element of a manufacturing device 1, and detects an abnormality generated in the execution of a manufacturing process. In a process evaluation part 105, an alarm severity judgment part 1051 judges an influence (“alarm severity”) exerted by this abnormality upon an object such as a product, a semi-finished product or a product in process. Further, an alarm recurrence prevention advice judgment part 1053 makes judgment about advice on the recurrence prevention of an abnormality (“alarm recurrence prevention advice”). A detailed screen SC3 showing executed process results presented on an output device 57 contains the alarm severity and the alarm recurrence prevention advice.

### BACKGROUND OF THE INVENTION

1. Field of the Invention

The present invention relates to an industrial process evaluation system for evaluating an industrial process executed by an industrial device, an industrial process evaluation method and a recording medium storing an industrial process evaluation program.

2. Description of the Background Art

An operator of a semiconductor manufacturing device has been notified of an abnormality generated in this semiconductor manufacturing device by using information relating to the abnormality presented on a display and the like. As an example, Japanese Patent Application Laid-Open No. 10-21079 (1998) introduces a technique for displaying the cause of an abnormality generated in a semiconductor manufacturing device and countermeasures therefor.

This conventionally employed technique suffers from difficulty in suitably handling an abnormality generated in a semiconductor manufacturing device.

When an abnormality is generated in a semiconductor manufacturing device, a user of this semiconductor manufacturing device is required to specify a manufacturing process that was executed at the time of generation of the abnormality, and to analyze an influence exerted by this abnormality upon an object that has been produced by the execution of this manufacturing process, in other words, to determine whether or not this object can be subjected to a next process step. Such analytical work requires a great deal of labor that may necessitate cooperation with a vendor of the semiconductor manufacturing device.

Moreover, when an abnormality is generated in a semiconductor manufacturing device, a user of this semiconductor manufacturing device should prevent a recurrence of the abnormality. The user is also required to make considerable effort for such prevention based on past experience or information provided by a vendor of the semiconductor manufacturing device.

These circumstances apply to manufacturing devices other than semiconductor manufacturing devices, and generally speaking, to all industrial devices for commercial use.

### SUMMARY OF THE INVENTION

The present invention is intended for an industrial process evaluation system for evaluating an industrial process executed by an industrial device.

According to the present invention, the industrial process evaluation system comprises: a detection part for detecting an abnormality generated in the execution of the industrial process; a first judgment part for judging an influence exerted by the abnormality upon an object to be processed by the industrial device by executing the industrial process; and an output part for outputting a result of judgment given by the first judgment part.

It is possible to know the influence exerted by the abnormality upon the object that is generated in the execution of the industrial process. Thus the abnormality can be suitably handled.

The present invention is also intended for an industrial process evaluation method for evaluating an industrial process executed by an industrial device. The present invention is further intended for a recording medium that stores an industrial process evaluation program.

It is therefore an object of the present invention to suitably handle the abnormality generated in the industrial device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows the entire configuration of a manufacturing process evaluation system according to a preferred embodiment of the present invention;

FIG. 2 is a block diagram schematically showing the configuration of a manufacturing device;

FIG. 3 is a block diagram schematically showing the configuration of a manufacturing process evaluation management device;

FIG. 4 shows a detailed example of an alarm severity table when the manufacturing device is a cleaning device for use in the manufacture of semiconductor;

FIG. 5 shows a detailed example of an alarm recurrence prevention advice table when the manufacturing device is a cleaning device for use in the manufacture of semiconductor;

FIG. 6 shows a detailed example of a list screen showing executed process results presented on an output device when process evaluation information is viewed;

FIG. 7 shows a detailed example of a detailed screen showing executed process results that is presented on the output device in response to the press of detailed information viewing buttons on the list screen showing executed process results;

FIG. 8 shows a detailed example of an evaluation screen that is presented on the output device in response to the press of an evaluation button on the detailed screen showing executed process results;

FIG. 9 is a flow diagram showing the operation of the manufacturing process evaluation system when the process evaluation information is accumulated in a manufacturing process evaluation database;

FIG. 10 is a flow diagram showing the operation of the manufacturing process evaluation system when the process evaluation information accumulated in the manufacturing process evaluation database is viewed;

FIG. 11 is a flow diagram showing the operation of the manufacturing process evaluation system when process evaluation result feedback information is accumulated in the manufacturing process evaluation database;

FIG. 12 is a flow diagram showing the operation of the manufacturing process evaluation system when the process evaluation result feedback information accumulated in the manufacturing process evaluation database is retrieved by a vendor of the manufacturing device; and

FIG. 13 is a flow diagram showing the operation of the manufacturing process evaluation system when the alarm severity table and the alarm recurrence prevention advice table are updated.

### DESCRIPTION OF THE PREFERRED EMBODIMENTS

In the following, it will be discussed how to evaluate an influence that is exerted by an abnormality generated in an industrial device upon an object to be processed by this industrial device, and how to output evaluation result.

Here, an “industrial device” means a device for commercial use, and more particularly, a manufacturing device for making products to be discussed in detail below.

<1. Configuration of Manufacturing Process Evaluation System>

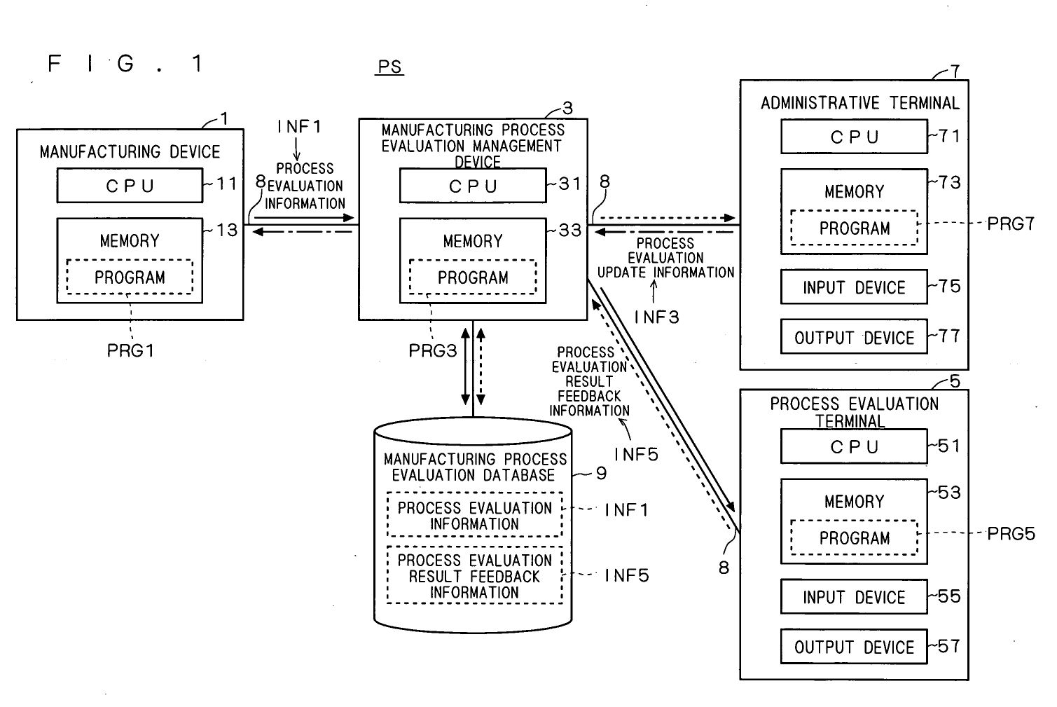

FIG. 1 schematically shows the entire configuration of a manufacturing process evaluation system PS according to a preferred embodiment of the present invention.

As shown in FIG. 1, the manufacturing process evaluation system PS comprises a manufacturing device 1 for executing a manufacturing process, a manufacturing process evaluation management device 3 responsible for the management of a manufacturing process evaluation database 9 that stores information INF1 relating to the evaluation of the manufacturing process (hereinafter referred to as “process evaluation information INF1”), a process evaluation terminal 5 for use in the consultation of the process evaluation information INF1, and an administrative terminal 7 for use in the control of the manufacturing process evaluation system PS. In FIG. 1, arrows with solid lines represent the flow of the process evaluation information INF1, arrows with dashed-dotted lines represent the flow of information INF3 relating to the contents of update of judgment data that is used as a basis for judging the process evaluation information INF1 (hereinafter referred to as “process evaluation update information INF3”), and arrows with dotted lines represent the flow of information INF5 relating to the validity of the process evaluation information INF1 (hereinafter referred to as “process evaluation result feedback information INF5”). According to the configuration of FIG. 1, the manufacturing process evaluation system PS is shown to include one manufacturing device 1, one process evaluation terminal 5 and one administrative terminal 7. The manufacturing process evaluation system PS may alternatively include two or more manufacturing devices 1, process evaluation terminals 5 and administrative terminals 7.

The manufacturing process evaluation management device 3 functioning as a server of the manufacturing process evaluation system PS is communicatively connected through a network 8 to the manufacturing device 1, the process evaluation terminal 5 and the administrative terminal 7 functioning as clients. A protocol to be employed in the communication therebetween is not specifically limited. A unique protocol may be applied, or alternatively, general-purpose protocols such as HTTP or FTP may be used.

The manufacturing device 1 is equipped with a computer including at least a CPU 11 and a memory 13 for executing a program PRG1 that realizes an operation discussed later. Each time a manufacturing process is executed, the manufacturing device 1 sends the process evaluation information INF1 to the manufacturing process evaluation management device 3. If an abnormality is generated in the execution of the manufacturing process, the manufacturing device 1 adds information relating to the details of the abnormality to the process evaluation information INF1 which in turn is sent to the manufacturing process evaluation management device 3.

When the process evaluation update information INF3 is received from the manufacturing process evaluation management device 3, the manufacturing device 1 updates judgment data based on the received process evaluation update information INF3.

The manufacturing process evaluation management device 3 is a computer including at least a CPU 31 and a memory 33 for executing a program PRG3 that realizes an operation discussed later. When the process evaluation information INF1 is received from the manufacturing device 1, the manufacturing process evaluation management device 3 enters the received process evaluation information INF1 into the manufacturing process evaluation database 9. When the process evaluation result feedback information INF5 is received from the process evaluation terminal 5, the manufacturing process evaluation management device 3 enters the received process evaluation result feedback information INF5 into the manufacturing process evaluation database 9.

Further, when the process evaluation update information INF3 is received from the administrative terminal 7, the manufacturing process evaluation management device 3 sends the received process evaluation update information INF3 to the manufacturing device 1.

When a request for the process evaluation information INF1 is received from the process evaluation terminal 5, the manufacturing process evaluation management device 3 retrieves the process evaluation information INF1 as requested from the process evaluation database 9, and sends the retrieved process evaluation information INF1 to the process evaluation terminal 5.

When an instruction to obtain the process evaluation result feedback information INF5 is received from the administrative terminal 7, the manufacturing process evaluation management device 3 retrieves the process evaluation result feedback information INF5 from the process evaluation database 9 according to the instruction, and sends the retrieved process evaluation result feedback information INF5 to the administrative terminal 7.

The process evaluation terminal 5 is a computer including at least a CPU 51 and a memory 53. The process evaluation terminal 5 further includes as user interfaces an input device 55 such as a keyboard and a mouse, and an output device 57 such as a display and a printer. In the process evaluation terminal 5, a program PRG5 stored on the memory 53 is executed by the computer to thereby realize various functions and operations discussed later.

The process evaluation terminal 5 sends a request for the process evaluation information INF1 given through the input device 55 to the manufacturing process evaluation management device 3, and outputs the process evaluation information INF1 that is received from the manufacturing process evaluation management device 3 to the output device 57.

The administrative terminal 7 is also a computer including at least a CPU 71 and a memory 73. The administrative terminal 7 further includes as user interfaces an input device 75 such as a keyboard and a mouse, and an output device 77 such as a display and a printer. In the administrative terminal 7, a program PRG7 stored on the memory 73 is executed by the computer to thereby realize various functions and operations discussed later.

The administrative terminal 7 sends an instruction to obtain the process evaluation result feedback information INF5 given through the input device 75 to the manufacturing process evaluation management device 3, and outputs the process evaluation result feedback information INF5 that is received from the manufacturing process evaluation management device 3 to the output device 77.

<Manufacturing Device>

The manufacturing device 1 executes a manufacturing process to perform processing upon an object. Here, the “manufacturing process” means a series of operations to be performed upon an object.

The manufacturing device 1 of course includes a device for processing an object. The manufacturing device 1 also includes devices that are not responsible for the processing of an object, but are required in the manufacture of products and may have some influence upon the object. By way of example, the manufacturing device 1 includes an inspection device, a transport device and an environmental control device. The manufacturing device 1 further includes a cleaning device, a heat treatment device, a heat treatment device, an impurity implantation device, a thin film deposition device, a lithography device, a planarization device and the like that are used for the manufacture of semiconductor. These devices are given only as examples of the manufacturing device 1, and do not limit the scope of application of the present invention.

The manufacturing device 1 is responsible for some or all steps in the manufacture of products. This means the manufacturing device 1 is not required to perform all steps in the manufacture of products, but may be required only to perform some step in the manufacture of products. As an example, in a process of manufacturing semiconductor that repeatedly performs a cleaning step, a heat treatment step, an impurity implantation step, a thin film deposition step, a lithography step, a planarization step and the like, the manufacturing device 1 may be responsible only for the cleaning step.

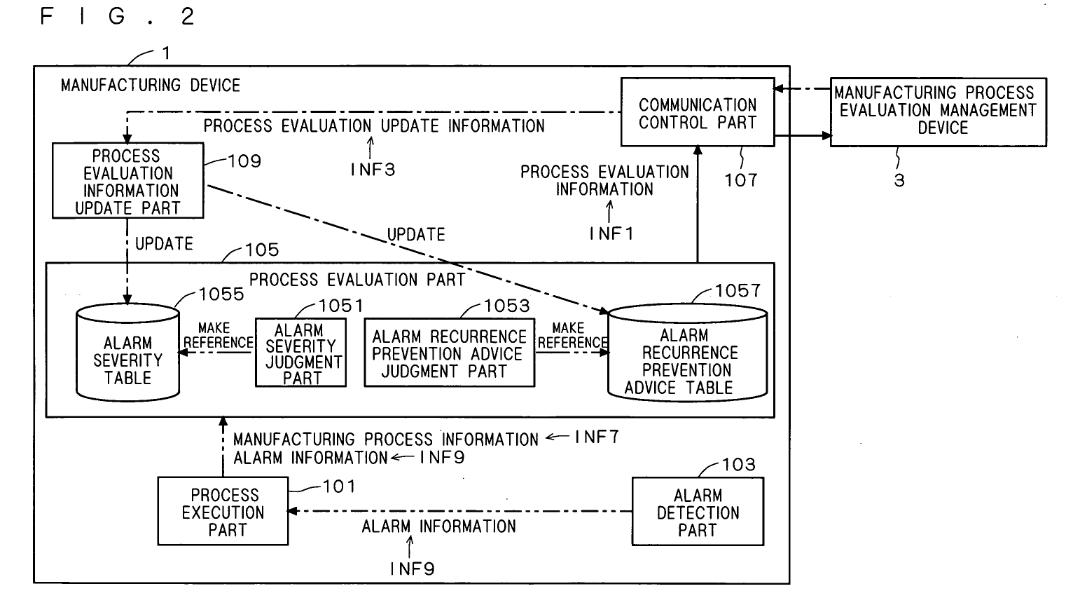

Next, the manufacturing device 1 will be described with reference to the block diagram of FIG. 2 schematically showing the configuration of the manufacturing device 1. The program PRG1 stored on the memory 13 is executed by the computer to thereby realize functions schematically represented as a process execution part 101, an alarm detection part 103, a process evaluation part 105 (including an alarm severity judgment part 1051 and an alarm recurrence prevention advice judgment part 1053), a communication control part 107 and a process evaluation information update part 109 shown in FIG. 2. In FIG. 2, arrows with solid lines represent the flow of the process evaluation information INF1, and arrows with dashed-dotted lines represent the flow of the process evaluation update information INF3.

The process execution part 101 controls the overall configuration of the manufacturing device 1 to execute a manufacturing process.

When a manufacturing process is completed, the process execution part 101 sends information INF7 relating to the manufacturing process (hereinafter referred to as “manufacturing process information INF7”) to the process evaluation part 105. The manufacturing process information INF7 includes “name of device”, “date and time of process execution”, “name of process executed”, “name of recipe executed” and “result of process execution”. As the “result of process execution”, “successful completion” is sent to the process evaluation part 105 when the manufacturing process is successfully completed. When an abnormality is generated in the execution of the manufacturing process, “alarm generated”, “warning generated” or “caution generated” is sent to the process evaluation part 105 according to the severity of the abnormality.

When information INF9 relating to the details of abnormality (hereinafter referred to as “alarm information INF9”) is received from the alarm detection part 103, the process execution part 101 sends the alarm information INF9 together with the manufacturing process information INF7 to the process evaluation part 105. The alarm information INF9 includes “date and time of alarm generation”, “alarm level”, “part abnormality is generated in” and “details of alarm”. As the “alarm level”, “alarm”, “warning” or “caution” is sent to the process evaluation part 105 according to the severity of the abnormality.

The alarm detection part 103 monitors each part of the manufacturing device 1, and detects an abnormality generated in the execution of a manufacturing process. When the alarm detection part 103 detects an abnormality, the alarm detection part 103 sends the alarm information INF9 to the process execution part 101. Here, an “abnormality” means a situation in which the operation or condition of the manufacturing device 1 is out of a predetermined allowable range.

The process evaluation part 105 judges the presence or absence of an abnormality in the execution of a manufacturing process based on the presence or absence of the alarm information INF9 sent from the process execution part 101. When it is determined that an abnormality is generated, the process evaluation part 105 performs evaluation of the manufacturing process.

More specifically, when the process evaluation part 105 determines that an abnormality is generated, the alarm severity judgment part 1051 judges an influence exerted by this abnormality upon an object (hereinafter referred to as “alarm severity”) such as a product, a semi-finished product or a product in process. Then the alarm recurrence prevention advice judgment part 1053 makes judgment about advice on the recurrence prevention of an abnormality (hereinafter referred to as “alarm recurrence prevention advice”). In this case, the process evaluation part 105 adds the alarm severity and the alarm recurrence prevention advice to the alarm information INF9, and then sends the process evaluation information INF1 including the manufacturing process information INF7 and the alarm information INF9 to the communication control part 107.

When the process evaluation part 105 determines that no abnormality is generated, the process evaluation part 105 does not judge the alarm severity and the alarm recurrence prevention advice. In this case, the process evaluation part 105 sends the manufacturing process information INF7 as the process evaluation information INF1 to the communication control part 107.

The communication control part 107 establishes communication with a communication control part 311 of the manufacturing process evaluation management device 3. The communication control part 107 outputs the process evaluation information INF1 that is sent from the process evaluation part 105 to the manufacturing process evaluation management device 3, and sends the process evaluation update information INF3 that is received from the manufacturing process evaluation management device 3 to the process evaluation information update part 109. For the communication between the manufacturing device 1 and the manufacturing process evaluation management device 3, commonly used means for delivering information are employed such as COM (component object model), CORBA (common object request broker architecture), SOAP (simple object access protocol) and the like.

The manufacturing device 1 holds an alarm severity table 1055 and an alarm recurrence prevention advice table 1057 in the memory 13 that are used as judgment data for respectively judging the alarm severity and the alarm recurrence prevention advice. The alarm severity table 1055 and the alarm recurrence prevention advice table 1057 may be stored in an auxiliary storage device such as a hard disk drive.

The alarm severity judgment part 1051 and the alarm recurrence prevention advice judgment part 1053 respectively make reference to the alarm severity table 1055 and the alarm recurrence prevention advice table 1057 to thereby judge the alarm severity and the alarm recurrence prevention advice. When the process evaluation update information INF3 is sent from the communication control part 107, the process evaluation information update part 109 updates the alarm severity table 1055 and the alarm recurrence prevention advice table 1057 based on the received process evaluation update information INF3.

<Manufacturing Process Evaluation Management Device>

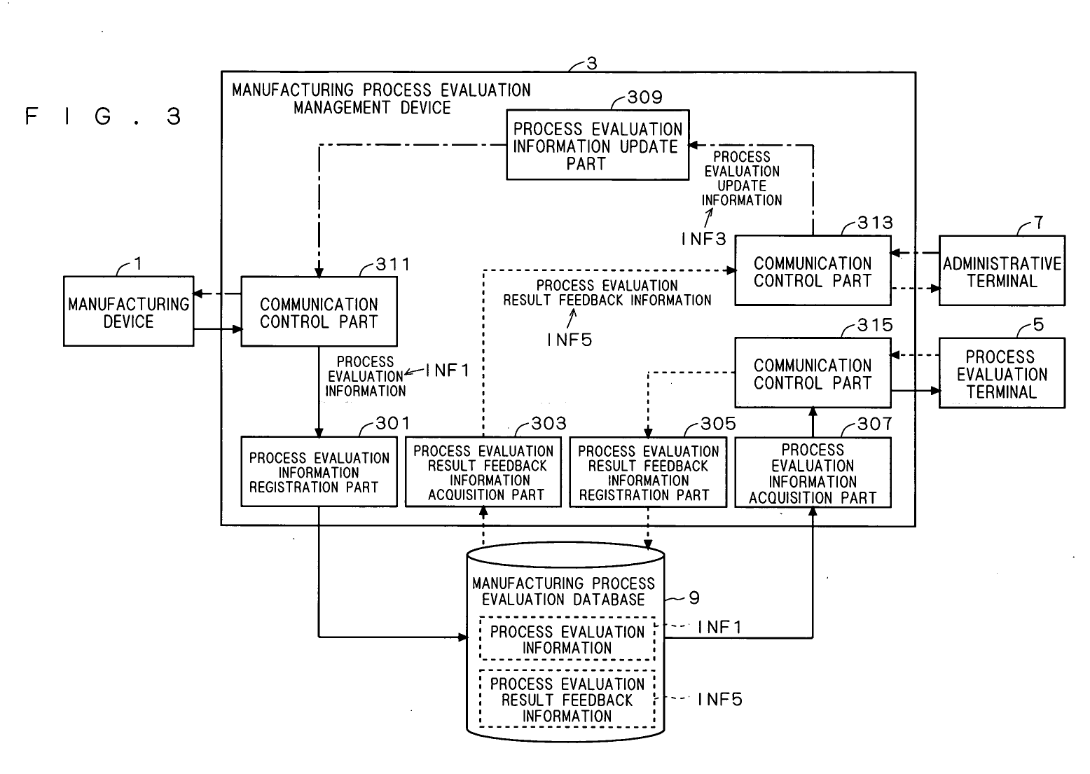

FIG. 3 is a block diagram schematically showing the configuration of the manufacturing process evaluation management device 3. The program PRG3 stored on the memory 33 is executed by the computer to thereby realize functions schematically represented as a process evaluation information registration part 301, a process evaluation result feedback information acquisition part 303, a process evaluation result feedback information registration part 305, a process evaluation information acquisition part 307, a process evaluation information update part 309, and communication control parts 311, 313 and 315. In FIG. 3, arrows with solid lines represent the flow of the process evaluation information INF1, arrows with dashed-dotted lines represent the flow of the process evaluation update information INF3, and allows with dotted lines represent the flow of the process evaluation result feedback information INF5.

The communication control part 311 establishes communication with the communication control part 107 of the manufacturing device 1. The communication control part 311 outputs the process evaluation information INF1 that is sent from the manufacturing device 1 to the process evaluation information registration part 301. Further, the communication control part 311 outputs the process evaluation update information INF3 that is sent from the process evaluation information update part 309 to the manufacturing device 1.

The process evaluation information registration part 301 enters the process evaluation information INF1 that is sent from the communication control part 311 into the manufacturing process evaluation database 9. For the entry of the process evaluation information INF1 into the manufacturing process evaluation database 9, commonly used means for delivering information are employed such as ODBC (open database connectivity), ADO (activeX data objects) and the like.

The communication control part 315 establishes communication with the process evaluation terminal 5. The communication control part 315 sends the process evaluation result feedback information INF5 that is received from the process evaluation terminal 5 to the process evaluation result feedback information acquisition part 305. Further, the communication control part 315 outputs the process evaluation information INFl that is received from the process evaluation information acquisition part 307 to the process evaluation terminal 5. For the communication between the manufacturing process evaluation management device 3 and the process evaluation terminal 5, commonly used means for delivering information are employed such as COM, CORBA, SOAP, HTTP and the like.

The process evaluation information acquisition part 307 retrieves the required process evaluation information INF1 from the manufacturing process evaluation database 9, and sends the retrieved process evaluation information INF1 to the communication control part 315. For the retrieval of the process evaluation information INF1 from the manufacturing process evaluation database 9, commonly used means for delivering information are employed such as ODBC, ADO and the like.

The process evaluation result feedback information registration part 305 enters the process evaluation result feedback information INF5 that is received from the communication control part 315 into the manufacturing process evaluation database 9. For the entry of the process evaluation result feedback information INF5 into the manufacturing process evaluation database 9, commonly used means for delivering information are employed such as ODBC, ADO and the like.

The communication control part 313 establishes communication with the administrative terminal 7. The communication control part 313 sends the process evaluation update information INF3 that is received from the administrative terminal 7 to the process evaluation information update part 309. Further, the communication control part 313 outputs the process evaluation result feedback information INF5 that is received from the process evaluation result feedback information acquisition part 303 to the administrative terminal 7.

The process evaluation result feedback information acquisition part 303 retrieves the required process evaluation result feedback information INF5 from the manufacturing process evaluation database 9, and sends the retrieved process evaluation result feedback information INF5 to the communication control part 313. For the retrieval of the process evaluation result feedback information INF5 from the manufacturing process evaluation database 9, commonly used means for delivering information are employed such as ODBC, ADO and the like.

The process evaluation information update part 309 sends the process evaluation update information INF3 that is received from the communication control part 313 to the communication control part 311.

<Alarm Severity Table>

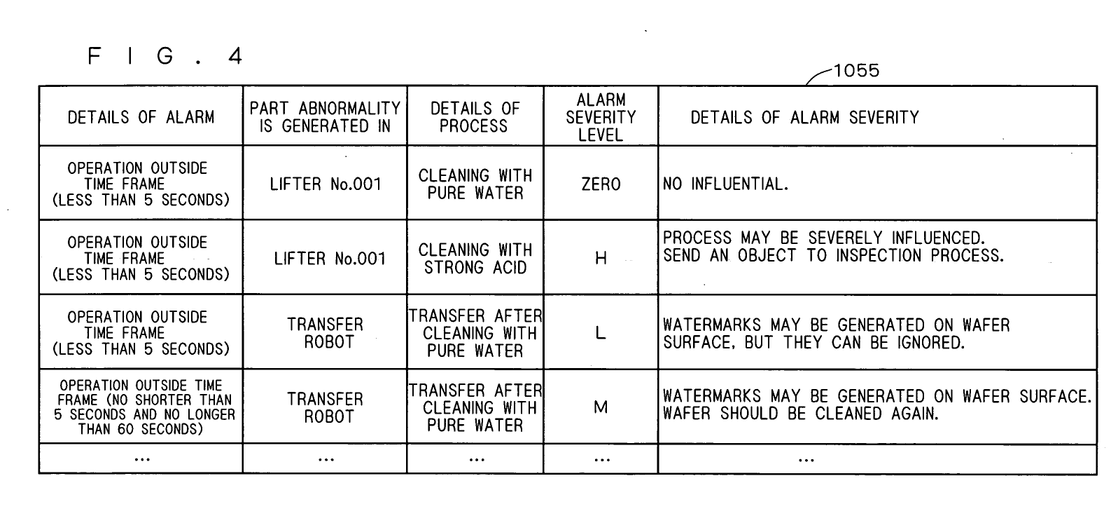

FIG. 4 shows a detailed example of the alarm severity table 1055 when the manufacturing device 1 is a cleaning device for use in the manufacture of semiconductor.

With reference to FIG. 4, the alarm severity table 1055 contains correspondences between “details of alarm”, “part abnormality is generated in” and “details of process” that are specified from the manufacturing process information INF7 and the alarm information INF9, and “alarm severity level” and “details of alarm severity” indicative of alarm severity.

Each time the manufacturing process information INF7 and the alarm information INF9 are given, the alarm severity judgment part 1051 makes reference to the alarm severity table 1055 using “details of alarm”, “part abnormality is generated in” and “details of process” as search keys. Then “alarm severity level” and “details of alarm severity” corresponding to these search keys are retrieved to thereby make judgment about the alarm severity. That is, the alarm severity judgment part 1051 makes judgment about alarm severity in consideration of the details of manufacturing process executed by the manufacturing device 1 in addition to the condition of the manufacturing device 1.

With reference to the alarm severity table 1055 shown in FIG. 4 as an example, when “details of alarm” is “operation outside a time frame (less than 5 seconds)”, “part abnormality is generated in” is “lifter No. 001” and “details of process” is “cleaning with pure water”, “alarm severity level” is “zero” and “details of alarm severity” is “no influential”. When “details of process” is changed to “cleaning with strong acid” with the same “details of alarm” and “part abnormality is generated in”, “alarm severity level” is changed to “H” and “details of alarm severity” is changed to “Process may be severely influenced. Send an object to inspection process”.

As discussed, the result of judgment about the alarm severity is changed in response to the manufacturing process information INF7 as well as the alarm information INF9, to thereby make proper judgment about the alarm severity.

<Alarm Recurrence Prevention Advice Table>

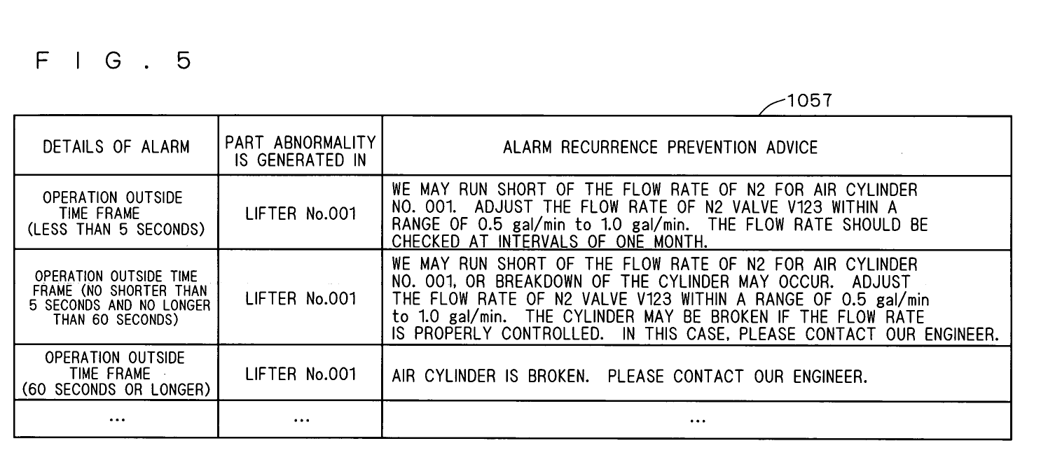

FIG. 5 shows a detailed example of the alarm recurrence prevention advice table 1057 when the manufacturing device 1 is a cleaning device for use in the manufacture of semiconductor.

With reference to FIG. 5, the alarm recurrence prevention advice table 1057 contains correspondences between “details of alarm” and “part abnormality is generated in” that are specified from the alarm information INF9, and “alarm recurrence prevention advice” that indicates advice on the alarm recurrence prevention.

Each time the alarm information INF9 is given, the alarm recurrence prevention advice judgment part 1053 makes reference to the alarm recurrence prevention advice table 1057 using “details of alarm” and “part abnormality is generated in” as search keys. Then “alarm recurrence prevention advice” corresponding to these search keys is retrieved to thereby judge the alarm recurrence prevention advice.

With reference to the alarm recurrence prevention advice table 1057 in FIG. 5 as an example, when “details of alarm” is “operation outside a time frame (less than 5 seconds)” and “part abnormality is generated in” is “lifter No. 001”, “alarm recurrence prevention advice” is “We may run short of the flow rate of N₂ for air cylinder No. 001. Adjust the flow rate of N₂ valve V123 within a range of 0.5 gal/min to 1.0 gal/min. The flow rate should be checked at intervals of one month”. When “details of alarm” is changed to “operation outside a time frame (no shorter than 5 seconds and no longer than 60 seconds)” with the same “part abnormality is generated in”, “alarm recurrence prevention advice” is changed to “We may run short of the flow rate of N₂ for air cylinder No. 001, or breakdown of the cylinder may occur. Adjust the flow rate of N₂ valve V123 within a range of 0.5 gal/min to 1.0 gal/min. The cylinder may be broken if the flow rate is properly controlled. In this case, please contact our engineer.” That is, the alarm recurrence prevention advice judgment part 1053 gives information relating to countermeasures against the maladjustment and the breakdown of the manufacturing device 1 considered to be the course of an abnormality as alarm recurrence prevention advice.

As discussed, the result of judgment about the alarm recurrence prevention advice is changed in response to the alarm information INF9, to thereby make proper judgment on the alarm recurrence prevention advice.

<List Screen Showing Executed Process Results>

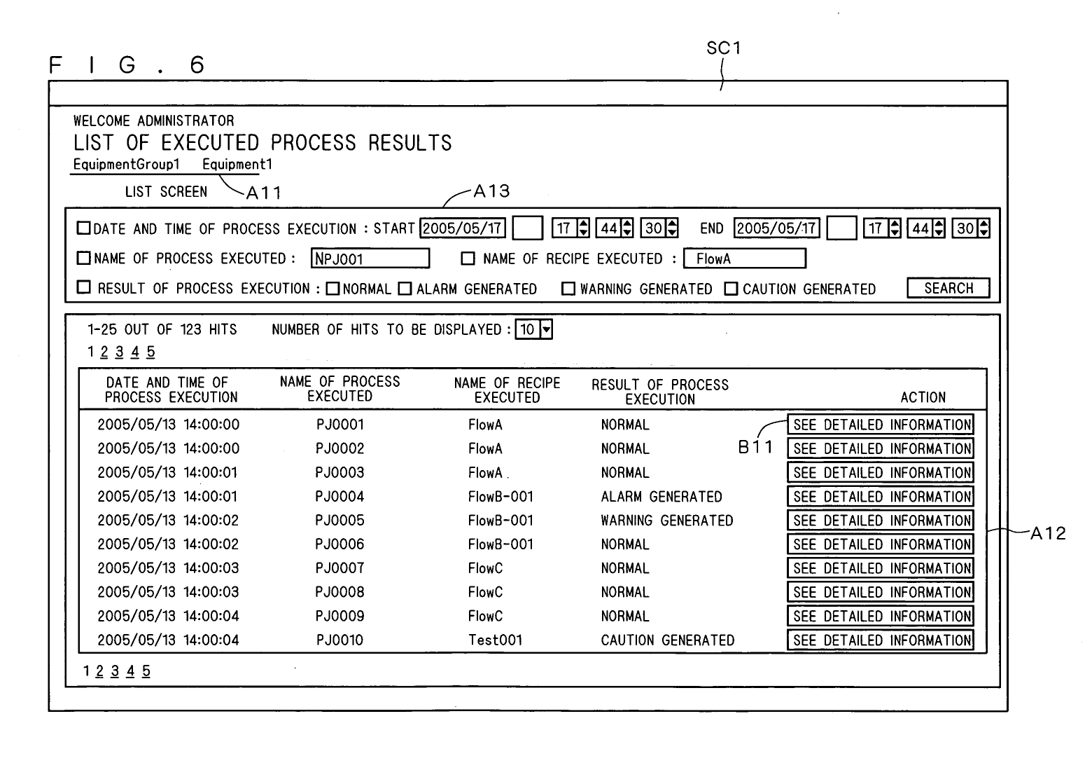

FIG. 6 shows a detailed example of a list screen SC1 showing executed process results presented on the output device (described as a display in the following) 57 when the process evaluation information INF1 is viewed.

As shown in FIG. 6, the list screen SC1 showing executed process results includes labels for “name of device”, “date and time of process execution”, “name of process executed”, “name of recipe executed” and “result of process execution” that are contained in the process evaluation information INF1.

The list screen SC1 showing executed process results shows “name of device” in an area A11.

Further, the list screen SC1 showing executed process results shows “date and time of process execution”, “name of process executed”, “name of recipe executed” and “result of process execution” in an area A12 that are given for each process evaluation information INF1 of the device with a name shown in the area A11. The list screen SC 1 showing executed process results contains detailed information viewing buttons B 11 used for calling up a detailed screen SC3 showing executed process results on the output device 57. Each detailed information viewing buttons B 11 corresponds to each piece of the process evaluation information INF1 shown in the area A12.

The list screen SC1 showing executed process results is capable of selecting the process evaluation information INF1 that satisfies search criteria designated in an area A13, and showing the extracted process evaluation information INF1 in the area A12. In the area A13, refine search is performed by designating “date and time of process execution”, “name of process executed”, “name of recipe executed” and “result of process execution” as search criteria to select the process evaluation information INF1. Then an operator is capable of viewing only the selected desirable process evaluation information INF1 as selected such as the one labeled as “alarm generation” in “result of process execution”. As a result, an operation related to process evaluation can be effectively performed.

<Detailed Screen Showing Executed Process Results>

FIG. 7 shows a detailed example of the detailed screen SC3 showing executed process results that is presented on the output device 57 in response to the press of the detailed information viewing buttons B11 on the list screen SC1 showing executed process results.

As shown in FIG. 7, on the detailed screen SC3 showing executed process results, “date and time of process execution”, “name of process executed”, “name of recipe executed” and “result of process execution” of the process evaluation information INF1 appear in an area A31. The process evaluation information INF1 appearing in the area A31 is responsive to the detailed information viewing button B 11 that was pressed on the list screen SC1 showing executed process results immediately before the list screen SC3 showing executed process results is presented.

The detailed screen SC3 showing executed process results shows “date and time of alarm generation”, “alarm level”, “details of alarm”, “part abnormality is generated in”, “details of process” and “alarm severity (alarm severity level)” in an area A32 that are given for each abnormality generated in the execution of the manufacturing process shown in the area A31.

The detailed screen SC3 showing executed process results also shows “alarm severity (details of alarm severity)” and “alarm recurrence prevention advice (advice for preventing recurrence of alarm)” in an area A33 relates to an abnormality selected by the click of “date and time of alarm generation” shown in the area A32.

The detailed screen SC3 showing executed process results contains an evaluation button BT31 used for calling up an evaluation screen SC5 for evaluating the alarm severity and the advice for recurrence prevention on the output device 57.

An operator views the alarm severity presented on the detailed screen SC3 showing executed process results to thereby see the influence exerted upon an object by an abnormality generated in the execution of a manufacturing process. This allows the operator to suitably handle this abnormality. As an example, when the manufacturing device 1 is a cleaning device for the manufacture of semiconductor, the operator is allowed to determine on the occurrence of an abnormality whether a wafer to be cleaned should be carried to an inspection step, the wafer to be cleaned should be carried to a next step ignoring the abnormality, or whether a cleaning process should be performed again.

The operator also views the alarm recurrence prevention advice presented on the detailed screen SC3 showing executed process results to thereby see the advice on preventing recurrence of an abnormality generated in the execution of a manufacturing process. This allows the operator to more suitably handle this abnormality. As an example, the operator is allowed to determine on the occurrence of an abnormality whether the manufacturing device 1 should be fixed up or repaired.

<Evaluation Screen>

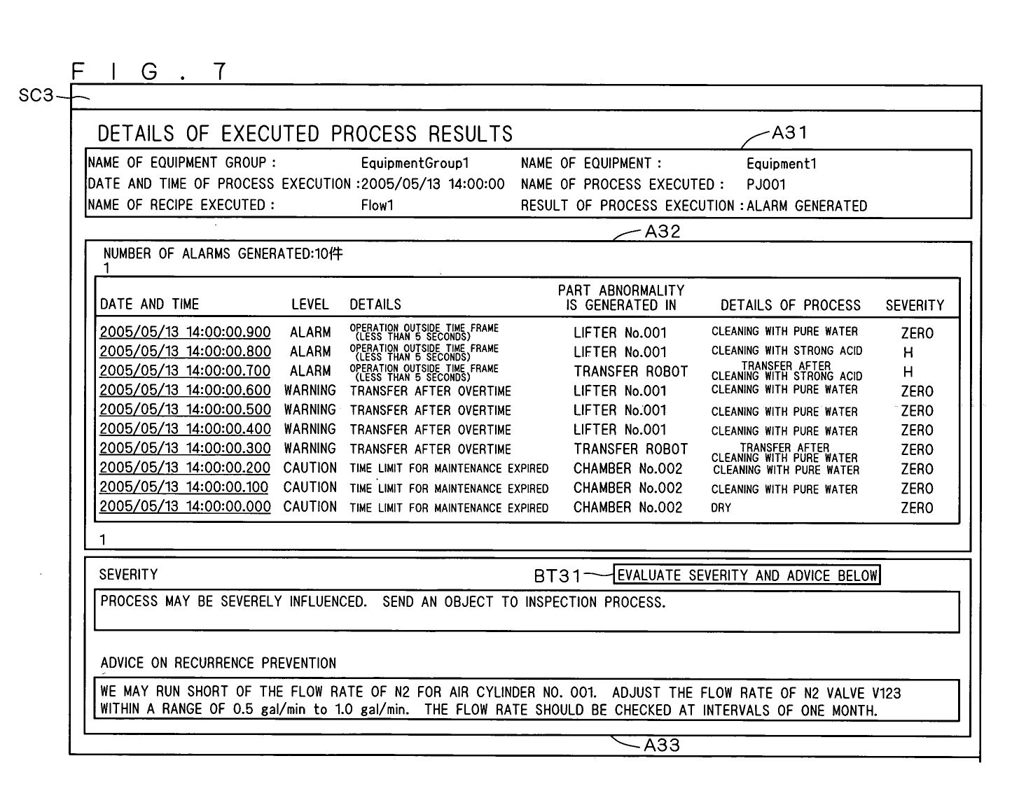

FIG. 8 shows a detailed example of the evaluation screen SC5 that is presented on the output device 57 in response to the press of the evaluation button BT31 on the detailed screen SC3 showing executed process results.

As shown in FIG. 8, on the evaluation screen SC5, “date and time of process execution”, “name of process executed”, “name of recipe executed” and “result of process execution” are given in an area A51 that were displayed in the area A31 on the detailed screen SC3 showing executed process results immediately before the evaluation screen SC5 is presented. Further, “alarm severity (details of alarm severity)” and “alarm recurrence prevention advice (advice for preventing recurrence of alarm)” are respectively given in areas A52 and A53 on the evaluation screen SC5 that were displayed in the area A33 on the detailed screen SC3 showing executed process results immediately before the evaluation screen SC5 is presented.

The evaluation screen SC5 contains a check box C51 in the area A52 that accepts the input of the validity (appropriateness) of “alarm severity (details of alarm severity)”. The evaluation screen SC5 also contains a check box C52 in the area A53 that accepts the input of the validity (appropriateness) of “alarm recurrence prevention advice (advice for preventing recurrence of alarm)”.

In the check box C51, one is selected from five alternatives “completely correct”, “correct”, “normal”, “not correct” and “completely incorrect”. In the check box C52, one is selected from five alternatives “quite helpful”, “helpful”, “normal”, “not helpful” and “completely useless”. That is, the most appropriate one is selected from a plurality of alternatives, whereby the process evaluation result feedback information INF5 is obtained from an operator without placing a heavy burden upon the operator. The acquired process evaluation result feedback information INF5 can be easily handled accordingly. However, this does not mean the process evaluation result feedback information INF5 cannot be acquired by an alternative way. By way of example, a score indicative of validity may be entered, or a comment on validity may be entered in the form of sentence.

In addition, the evaluation screen SC5 contains a registration button B51 used for giving instruction to register the process evaluation result feedback information INF5.

<2. Operation of Manufacturing Process Evaluation System>

<Accumulation of Process Evaluation Information>

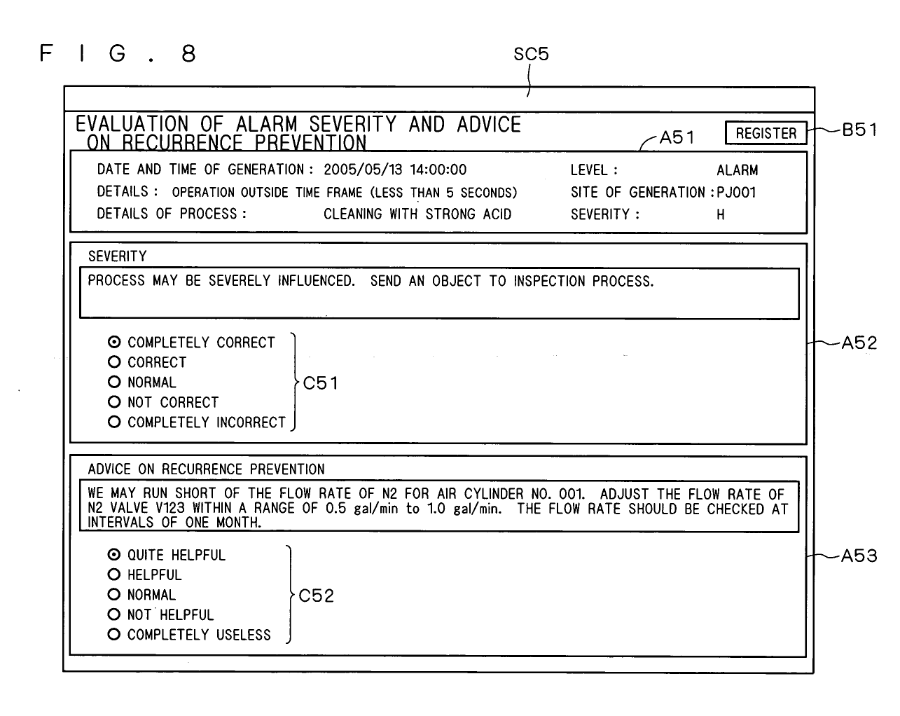

FIG. 9 is a flow diagram showing the operation of the manufacturing process evaluation system PS when the process evaluation information INF1 is accumulated in the manufacturing process evaluation database 9.

With reference to FIG. 9, for the accumulation of the process evaluation information INF1, the process execution part 101 of the manufacturing device 1 executes a manufacturing process first (step S101).

When the alarm detection part 103 detects an abnormality generated in the execution of the manufacturing process (when the result of step S102 is “YES”), the alarm detection part 103 sends the alarm information INF9 to the process execution part 101 (step S103). Then the process execution part 101 sends the manufacturing process information INF7 and the alarm information INF9 to the process evaluation part 105 (step S104). As a result, information required for judging the alarm severity and the alarm recurrence prevention advice is prepared, which more particularly means search keys required for the retrieval from the alarm severity table 1055 and the alarm recurrence prevention advice table 1057 are given.

In response, the alarm severity judgment part 1051 makes judgment about the alarm severity in consideration of the alarm severity table 1055 (step S105), and the alarm recurrence prevention advice judgment part 1053 makes judgment about the alarm recurrence prevention advice in consideration of the alarm recurrence prevention advice table 1057 (step S106). Then the process evaluation part 105 adds the alarm severity and the alarm recurrence prevention advice to the alarm information INF9, and thereafter sends the process evaluation information INF1 including the manufacturing process information INF7 and the alarm information INF9 through the communication control parts 107 and 311 to the process evaluation information registration part 301 of the manufacturing process evaluation management device 3 (step S1109).

When the alarm detection part 103 does not detect an abnormality, the process execution part 101 sends the manufacturing process information INF7 to the process evaluation part 105 (step S107). Then the process evaluation part 105 sends the manufacturing process information INF7 as the process evaluation information INF1 to the process evaluation information registration part 301 through the communication control parts 107 and 311 (step S109).

The process evaluation information registration part 301 in turn enters the received process evaluation information INF1 into the manufacturing process evaluation database 9 (step S110).

In the manufacturing process evaluation system PS, each time a manufacturing process is executed, steps S101 through S110 are repeatedly performed to thereby accumulate the process evaluation information INF1 given for each manufacturing process in the manufacturing process evaluation database 9. This does not mean that the present invention excludes a case where steps S107 and S108 are not performed and only the process evaluation information INF1 given the alarm severity and the alarm recurrence prevention advice is accumulated in the manufacturing process evaluation database 9, or a case where only part of the process evaluation information INF1 given the alarm severity and the alarm recurrence prevention advice, which for example the process evaluation information INF1 given the alarm severity level “H”, is accumulated in the manufacturing process evaluation database 9.

<View of Process Evaluation Information>

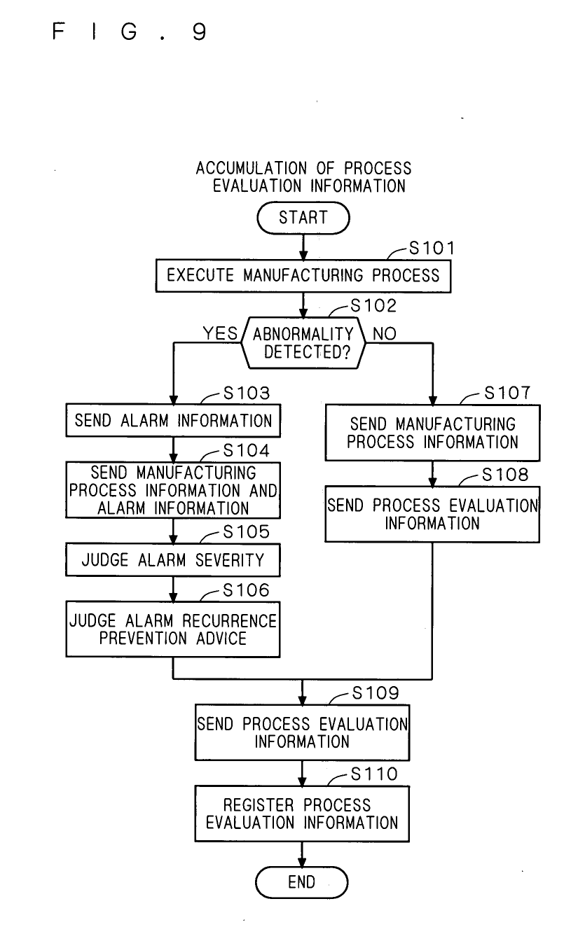

FIG. 10 is a flow diagram showing the operation of the manufacturing process evaluation system PS when the process evaluation information INF1 accumulated in the manufacturing process evaluation database 9 is viewed.

With reference to FIG. 10, in order to view the process evaluation information INF1, the process evaluation terminal 5 issues an instruction to obtain the process evaluation information INF1 with “name of device” designated by an operator by using the output device 55. This instruction is sent through the communication control part 315 to the process evaluation information acquisition part 307. For the issue of this instruction, the operator may of course designate search keys other than “name of device”. When a Web server is implemented into the manufacturing process evaluation management device 3, a general-purpose personal computer onto which a Web browser is installed can be used as the process evaluation terminal 5. Then the process evaluation terminal 5 is capable of issuing an instruction as an HTTP request.

In response, the process evaluation information acquisition part 307 retrieves the process evaluation information INF1 according to the instruction from the manufacturing process evaluation database 9 (step S202), and sends the retrieved process evaluation information INF1 through the communication control part 315 to the process evaluation terminal 5 (step S203). The process evaluation terminal 5 in turn presents the list screen SC1 showing executed process results on the output device 57 that contains the received process evaluation information INF1 (step S204).

In the manufacturing process evaluation system PS, the process evaluation information INF1 is once accumulated in the manufacturing process evaluation database 9. The accumulated process evaluation information INFl is then viewed by using the process evaluation terminal 5. This means only desirable process evaluation information INF1 is selected and viewed, whereby an operation related to process evaluation can be effectively performed.

<Accumulation of Process Evaluation Result Feedback Information>

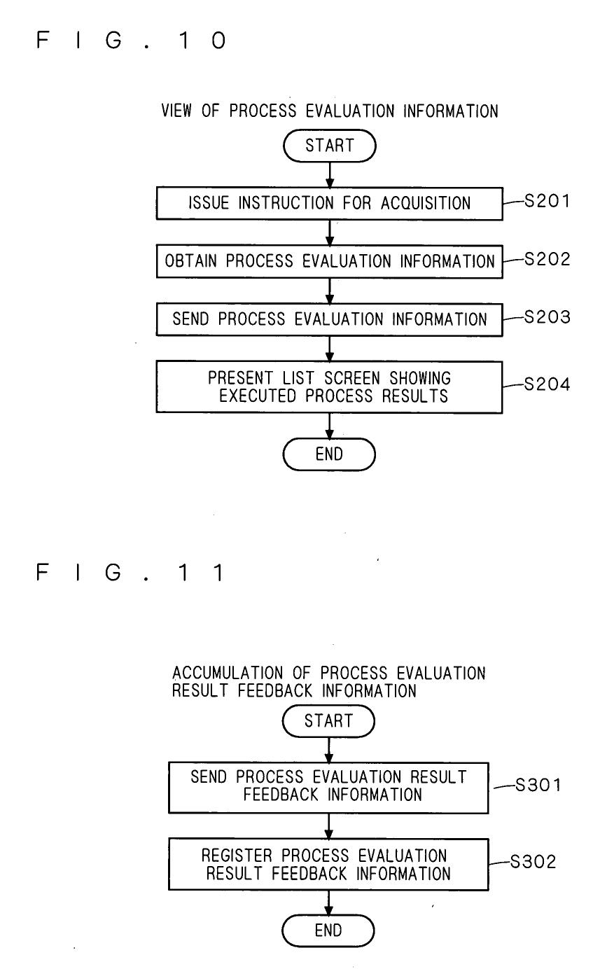

FIG. 11 is a flow diagram showing the operation of the manufacturing process evaluation system PS when the process evaluation result feedback information INF5 is accumulated in the manufacturing process evaluation database 9.

With reference to FIG. 11, for the accumulation of the process evaluation result feedback information INF5, the process evaluation terminal 5 sends, in response to the press of the registration button B51, the process evaluation result feedback information INF5 received by using the check boxes C51 and C52 through the communication control part 315 to the process evaluation result feedback information registration part 305 of the manufacturing process evaluation management device 3 (step S301).

In response, the process evaluation result feedback information registration part 305 enters the received process evaluation result feedback information INF5 into the manufacturing process evaluation database 9 (step S302).

In the manufacturing process evaluation system PS, the validity of alarm information and alarm recurrence prevention advice is judged on the evaluation screen SC5. Each time the registration button B51 is pressed, steps S301 and S302 are repeatedly performed to accumulate the process evaluation result feedback information INF5 in the manufacturing process evaluation database 9.

<Retrieval of Process Evaluation Result Feedback Information>

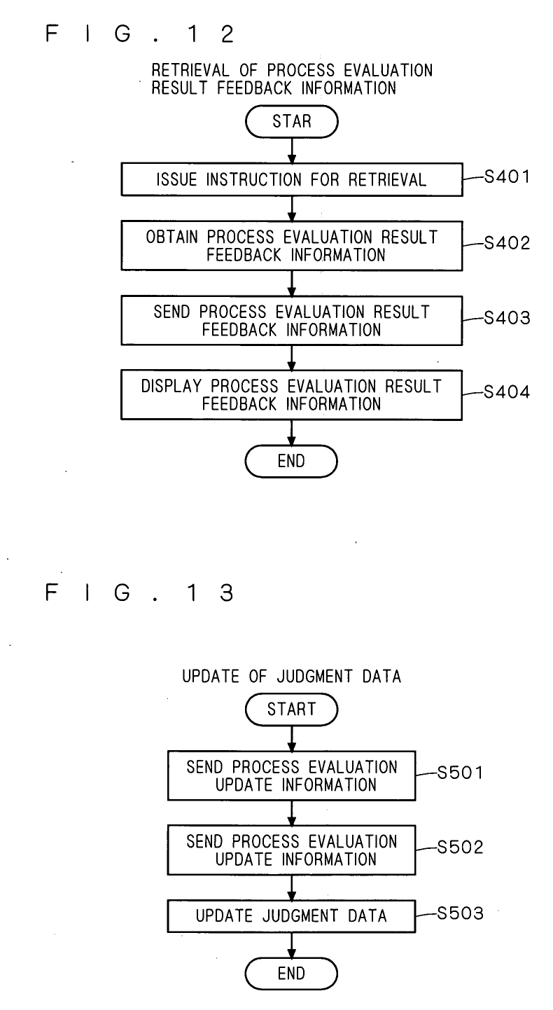

FIG. 12 is a flow diagram showing the operation of the manufacturing process evaluation system PS when the process evaluation result feedback information INF5 accumulated in the manufacturing process evaluation database 9 is retrieved by a vendor of the manufacturing device 1.

With reference to FIG. 12, for the retrieval of the process evaluation result feedback information INF5, the administrative terminal 7 issues and sends, in response to an action taken by an operator through the input device 75, an instruction for retrieval through the communication control part 313 to the process evaluation result feedback information acquisition part 303 of the manufacturing process evaluation management device 3 (step S401). For the issue of an instruction for retrieval, the date and time of registration and the like of the process evaluation result feedback information INF5 to be retrieved may be designated, of course.

In response, the process evaluation result feedback information acquisition part 303 retrieves the process evaluation result feedback information INF5 from the manufacturing process evaluation database 9 according to the instruction for retrieval (step S402). Then the retrieved process evaluation result feedback information INF5 is sent through the communication control part 313 to the administrative terminal 7 (step S403).

The administrative terminal 7 displays the received process evaluation result feedback information INF5 on the output device 77 (step S404). In place of, or in addition to the display of the process evaluation result feedback information INF5 on the output device 77, the received process evaluation result feedback information INF5 may be naturally entered into a storage, or may be transmitted to another computer (such as a computer installed in facilities of the vendor of the manufacturing device 1).

When the process evaluation result feedback information INF5 thereby retrieved is viewed, the alarm severity lacking in validity (inappropriate alarm severity) given negative evaluation result such as “not correct” or “completely incorrect” is found. Further, the alarm recurrence prevention advice lacking in validity (inappropriate alarm recurrence prevention advice) given negative evaluation result such as “not helpful” or “completely useless” is found. As a result, the validity of the alarm severity table 1055 and the alarm recurrence prevention advice table 1057 can be checked.

As discussed, in the manufacturing process evaluation system PS, a user of the manufacturing device 1 accumulates the process evaluation result feedback information INF5 which in turn is retrieved by a vendor of the manufacturing device 1. As a result, the evaluation of the alarm severity and the alarm recurrence prevention advice can be fed back from the user to the vendor of the manufacturing device 1.

<Update of Judgment Data>

FIG. 13 is a flow diagram showing the operation of the manufacturing process evaluation system PS when the alarm severity table 1055 and the alarm recurrence prevention advice table 1057 are updated. The update of judgment data is performed mainly when judgment data is deemed to be inappropriate as a result of the verification of the judgment data.

With reference to FIG. 13, for the update of judgment data, the administrative terminal 7 sends the process evaluation update information INF3 containing new judgment data that is suitably corrected through the communication control part 313 to the process evaluation information update part 309 of the manufacturing process evaluation management device 3 (step S501). The new judgment data may be entered into the administrative terminal 7 by using the input device 75. Alternatively, this new judgment data may be transmitted from another computer (such as a computer installed in facilities of a vendor of the manufacturing device 1). Still alternatively, a recording medium storing new judgment data may be read by the administrative terminal7.

In response, the process evaluation information update part 309 sends the received process evaluation update information INF3 through the communication control parts 311 and 107 to the process evaluation information update part 109 of the manufacturing device 1 (step S502).

The process evaluation information update part 109 in turn updates the alarm severity table 1055 and the alarm recurrence prevention advice table 1057 based on the received process evaluation update information INF3 (step S503). Then the contents of the alarm severity table 1055 and the alarm recurrence prevention advice table 1057 are replaced by suitably corrected ones, whereby the alarm severity judgment part 1051 and the alarm recurrence prevention advice judgment part 1053 are allowed to make suitable judgments. As a result, the process evaluation information INF1 that is accumulated in the manufacturing process evaluation database 9 after the update of the alarm severity table 1055 and the alarm recurrence prevention advice table 1057 is properly applicable. This means feedback of evaluation from a user to a vendor of the manufacturing device 1 is properly given.

### Other Examples

In the preferred embodiment described above, the alarm severity and the alarm recurrence prevention advice are judged in synchronization with the generation of an abnormality. Alternatively, the manufacturing process information INF7 and the alarm information INF9 may be accumulated at the time of generation of an abnormality. In this case, the alarm severity and the alarm recurrence prevention advice may be judged in synchronization with an instruction to obtain the process evaluation information INF1. Further, the alarm severity and the alarm recurrence prevention advice are not necessarily judged inside the manufacturing device 1, but may alternatively be judged inside the manufacturing process evaluation management device 3.

In the preferred embodiment described above, the process evaluation information INF1 is once accumulated in the manufacturing process evaluation database 9, and is thereafter viewed using the process evaluation terminal 5. Alternatively, the process evaluation information INF1 may be presented in real time on an output device such as a display or a printer arranged in the manufacturing device 1 or in the manufacturing process evaluation management device 3. In this case, an abnormality that requires emergency response can be easily handled.

While the invention has been shown and described in detail, the foregoing description is in all aspects illustrative and not restrictive. It is therefore understood that numerous modifications and variations can be devised without departing from the scope of the invention.

What is claimed is:

1. An industrial process evaluation system for evaluating an industrial process executed by an industrial device, comprising:
a detection part for detecting an abnormality generated in the execution of said industrial process;
a first judgment part for judging an influence exerted by said abnormality upon an object to be processed by said industrial device by executing said industrial process; and
an output part for outputting a result of judgment given by said first judgment part.

2. The industrial process evaluation system according to claim 1, further comprising:
a first update part for updating data for use as a basis for judgment by said first judgment part.

3. The industrial process evaluation system according to claim 1, further comprising:
a second judgment part for judging advice on the recurrence prevention of said abnormality,
wherein said output part outputs a result of judgment given by said second judgment part in addition to said result of judgment given by said first judgment part.

4. The industrial process evaluation system according to claim 3, further comprising:
a second update part for updating data for use as a basis for judgment by said second judgment part.

5. The industrial process evaluation system according to claim 1, further comprising:
a receiving part for receiving the validity of an output given by said output part.

6. An industrial process evaluation method for evaluating an industrial process executed by an industrial device, comprising the steps of:
a) detecting an abnormality generated in the execution of said industrial process;
b) judging an influence exerted by said abnormality upon an object to be processed by said industrial device by executing said industrial process; and
c) outputting a result of judgment given by said step b).

7. A recording medium that stores an industrial process evaluation program for evaluating an industrial process executed by an industrial device, said industrial process evaluation program being executed by a computer by causing said computer to perform the following steps of:
a) detecting an abnormality generated in the execution of said industrial process;
b) judging an influence exerted by said abnormality upon an object to be processed by said industrial device by executing said industrial process; and
c) outputting a result of judgment given by said step b).
